(19) United States
(12) Patent Application Publication
(10) Pub. No.: US 2009/0081268 A1
(43) Pub. Date: Mar. 26, 2009

(54) ANTIBACTERIAL NECK-TIE

(76) Inventor: Paolo PIANEZZA, Azzio (Varese) (IT)

Correspondence Address: SUGHRUE MION, PLLC, 2100 PENNSYLVANIA AVENUE, N.W., SUITE 800, WASHINGTON, DC, 20037, US

(21) Appl. No.: 12/193,488

(22) Filed: Aug. 18, 2008

(30) Foreign Application Priority Data
Sep. 21, 2007 (IT) T02007U000119

(51) Int. Cl. A01N 25/34; A01P 1/00

(52) U.S. Cl. 424/404

(57) ABSTRACT

The neck-tie according to the present invention is made with an antibacterial yarn. This yarn presents intrinsic antibacterial properties and performs both a bacteriostatic and a bactericidal function. Said yarn is obtained by means of a procedure that entails adding, before the spinning phase, an antibacterial agent that comprises a dispersion of silver atoms or ions directly to the material that will go to form the yarn.

### BACKGROUND OF THE INVENTION

The present invention concerns the field of clothing accessories, and specifically neck-ties.

The purpose of the invention is to produce a neck-tie that, while conserving all the necessary characteristics required to optimally perform the function of clothing accessory for which it is destined, at the same time makes it possible to minimise the origin and multiplication of bacteria, microbes, fungi, viruses, germs and parasites inside the fabric of the neck-tie.

### SUMMARY OF THE INVENTION

In view of achieving this purpose, the present invention has as its object a neck-tie characterised in that it is made with an antibacterial yarn.

In the present description and in the attached claims, by “antibacterial yarn” it is intended to indicate both a “bacteriostatic” yarn, that is a yarn capable of inhibiting the proliferation and reproduction of bacteria, and a “bactericidal” yarn, that is a yarn capable of eliminating bacteria that come into contact with, or are deposited on, the yarn.

It should be noted that of themselves antibacterial yarns are already known to technology and are likewise available on the market. However, the idea of applying a yarn of this type to a neck-tie, in order to give it a new utility, forms the specific object of the present invention.

Thanks to the above characteristics, the neck-tie according to the present invention may in fact to used to advantage by health-sector professionals, and in particular by medical and nursing staff working in contact with patients in hospital settings and in medical surgeries, in order to limit the proliferation and transmission of bacteria, as well as in general by whomsoever is aware of this problem.

### BRIEF DESCRIPTION OF THE DRAWINGS

Further characteristics of the invention will be clear in the following description, with reference to the attached drawings, provided as a simple non-limiting example, in which:

FIG. 1 shows an example of a neck-tie according to the present invention,

FIG. 2 shows the neck-tie of FIG. 1 in the tied condition, and

FIG. 3 shows a second example of a neck-tie according to the present invention.

### DETAILED DESCRIPTION OF THE INVENTION

As already indicated above, in the present description by “antibacterial yarn” it is intended to indicate both a “bacteriostatic” yarn, that is a yarn capable of inhibiting the proliferation and reproduction of bacteria, and a “bactericidal” yarn, that is a yarn capable of eliminating bacteria that come into contact with the yarn or are deposited on it.

The need to protect fabrics from bacterial contamination has over the years led to the development of two different types of production process to obtain antibacterial yarns.

The first production process involves applying a protective antibacterial coating to a yarn made of natural, synthetic or artificial fibres, on conclusion of the spinning phase and during the finishing phase. This process is also known by the term nobilitation. Fabric woven with such yarn has an antibacterial property that is substantially located on its outer surface. In this case successive cycles of washing or cleaning the fabric may alter the protective coating, decreasing its antibacterial effectiveness. Furthermore, since the antibacterial substance is present on the external protective coating, it can easily be transferred, by contact, from the fabric to the user's skin, thus creating a possible source of allergies and/or dermatitis.

The second production process entails adding an antibacterial agent (comprised for example of silver atoms or ions) directly to the material that will be employed to form the yarn, before the spinning phase. This second production process is particularly advantageous for the production of yarns of synthetic or artificial fibre. The fabric made with this yarn will be provided with intrinsic antibacterial properties, incorporated within the structure of the yarn. In this way the antibacterial efficacy is guaranteed over time, whereas the mechanical and aesthetic characteristics of the yarn remain substantially unchanged.

Antibacterial properties may act in two different ways:

by contact, in which the antibacterial agent placed on the fibre does not disperse externally, and in which contact between the bacterium and the fibre is necessary to achieve an antibacterial action, or

by diffusion, in which the antibacterial agent placed on the surface or within the fibre is capable of dispersing at varying rates in a damp external medium to reach the bacteria and inhibit their proliferation.

On the market there are numerous antibacterial yarns developed for different applications.

As examples, we mention the yarn known under the trade-name “Meryl Skinlife”, which is a yarn of polyamide microfibre with silver ions present in the polymer matrix marketed by the French manufacturers Nylstar, and the yarn “Trevira Bioactive”, marketed by the German company Trevira, which is a synthetic polyester fibre with silver ions that give the fabric very elevated hygienic requisites.

The antibacterial properties of yarns that contain silver ions are permanent, since the antibacterial agent is present within the polymer matrix of the yarn. In fabrics that contain silver ions the antibacterial properties occur by contact with the bacteria.

Furthermore, the bacteriostatic properties of silver ions have also been found to be very useful to prevent the formation of unpleasant smells, allergies, and skin irritations.

The bactericidal action of silver ions occurs through the creation of a chemical bond with some of the protein components of the bacteria, causing denaturing and in consequence mortal damage to their metabolism.

The silver ions are inserted chemically within the fibres of the fabric during the production process, and thus they exercise their bactericidal function without migrating on the surface of the fabric and thence to the epidermis of the zones with which the fabric is in contact. This type of fabric is thus harmless both for the user and for the environment and it maintains its antibacterial qualities unaltered over time.

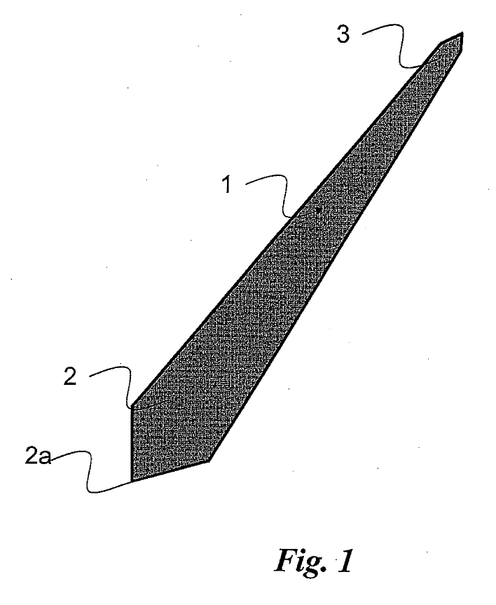

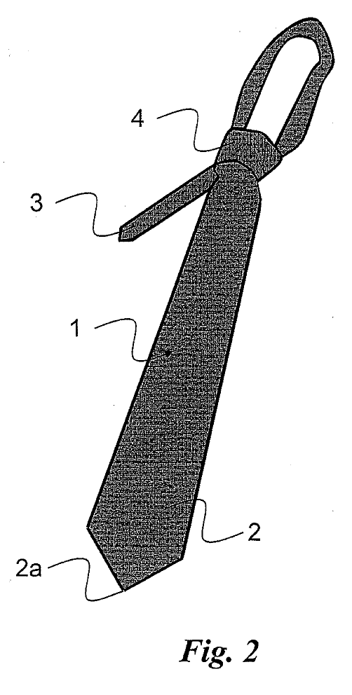

With reference to FIG. 1, the neck-tie comprises a body 1 made of fabric. The body 1 of the neck-tie presents the characteristic strip shape with one wide end 2 and a second narrow end 3. The narrow end 3 of the neck-tie 1, during use (see FIG. 2), is made to pass beneath the collar of a shirt and tied in different ways to make a knot 4. On the contrary, during use, the wide end 2 is made to hang down the chest such that the end portion 2a of said wide end reaches the level of the user's trousers. The terminal portions of the two ends 2 and 3 also present the characteristic pointed shape.

The body 1 of the neck-tie according to the present invention is made with an antibacterial yarn with intrinsic antibacterial properties. This yarn is generally produced with a process that entails adding, before the spinning phase, an antibacterial agent directly to the material that will be used to form the yarn. For preference, the added antibacterial agent comprises a dispersion of silver atoms or ions that give the yarn permanent antibacterial properties.

In a preferred variant, in order to identify univocally the neck-ties according to the present invention, the neck-tie bears the inscription “antibacterial” or the translation of that word into other languages. This inscription may be made in different ways, for example it may be part of the design of the neck-tie, it may be embroidered on the fabric or it may be applied onto it.

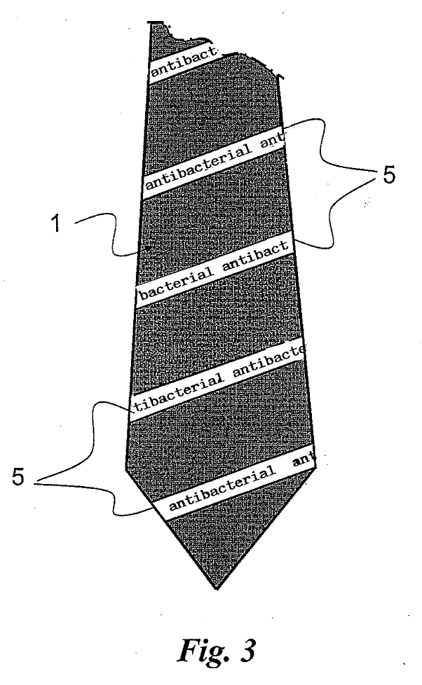

In the example shown in FIG. 3 the inscription appears repeatedly, in stripes 5, oblique and distanced from one another, that interrupt the background design of the neck-tie, giving the neck-tie a “Regimental” type appearance.

The neck-tie according to the present invention can be made with a solid colour fabric or of a fabric that presents any sort of design.

Naturally, the principle of the invention holding good, the construction details may vary widely with respect to what is described illustrated as a simple example.

What is claimed is:

1. Neck-tie characterised in that it is made with an antibacterial yarn.

2. Neck-tie according to claim 1, wherein said yarn presents intrinsic antibacterial properties.

3. Neck-tie according to claim 2, wherein said yarn is obtained by means of a procedure that entails adding, before the spinning phase, an antibacterial agent directly to the material that will be used to form the yarn.

4. Neck-tie according to claim 3, wherein said antibacterial agent comprises a dispersion of silver atoms or ions.

5. Neck-tie according to claim 1, wherein said antibacterial yarn performs a bactericidal function.

6. Neck-tie according to claim 1, wherein said antibacterial yarn performs a bacteriostatic function.

7. Neck-tie according to claim 1, wherein the neck-tie bears the inscription “antibacterial” or the translation of that word into other languages.

8. Neck-tie according to claim 7, wherein said inscription may be produced on the neck-tie in different ways:
woven within the design of the neck-tie,
embroidered on the fabric of the neck-tie, or
applied onto the fabric of the neck-tie.

9. Neck-tie according to claim 7, wherein said inscription appears repeatedly, in oblique stripes, distanced from one another, that interrupt the background design of the neck-tie.
